(19) United States
(12) Patent Application Publication
(10) Pub. No.: US 2009/0151173 A1
(43) Pub. Date: Jun. 18, 2009

(54) Guide Bar Arrangement

(75) Inventor: Werner Galster, Aspach (DE)

Correspondence Address: GUDRUN E. HUCKETT DRAUDT, SCHUBERTSTR. 15A, WUPPERTAL, 42289, DE

(73) Assignee: ANDREAS STIHL AG & CO. KG, Waiblingen (DE)

(21) Appl. No.: 12/332,550

(22) Filed: Dec. 11, 2008

(30) Foreign Application Priority Data
Dec. 17, 2007 (DE) 10 2007 060 683.6

(51) Int. Cl. B27B 17/04

(52) U.S. Cl. 30/385

(57) ABSTRACT

A guide bar arrangement has a guide bar having a guide groove that extends about an outer circumference of the guide bar. A saw chain is driven in circulation in the guide groove about the guide bar. The guide groove is delimited by a groove base, a first sidewall and a second sidewall positioned opposite the first sidewall. The guide bar has an opening for supply of oil into the guide groove, wherein the opening extends from an exterior side of the guide bar, wherein the exterior side extends in a longitudinal direction of the guide bar, into the guide groove and opens in the first sidewall into the guide groove. An insert is secured in the opening and reduces a free flow cross-sectional area of the opening.

### BACKGROUND OF THE INVENTION

The invention concerns a guide bar arrangement comprising a guide bar and a saw chain driven in circulation, wherein the guide bar has a guide groove that extends about the outer circumference of the guide bar and in which the saw chain is guided. The guide groove is delimited by a groove base and two oppositely positioned sidewalls. The guide bar has an opening for supply of oil that extends from an exterior side of the guide bar, extending in the longitudinal direction of the guide bar, into the guide groove and that opens in a first sidewall into the guide groove.

U.S. Pat. No. 4,211,007 discloses a guide bar that has two oppositely positioned oil bores. The oil bores are arranged in the sidewalls of the guide groove. Such oil bores can become clogged in operation by chips or the like so that the oil supply to the saw chain is impaired.

### SUMMARY OF THE INVENTION

It is an object of the invention to provide a guide bar arrangement of the aforementioned kind with which excellent lubrication of the saw chain can be ensured.

This object is solved by a guide bar arrangement wherein in the opening an insert is secured that reduces the free flow cross-sectional area of the opening.

An insert is provided for the guide bar arrangement and is secured in the opening for supplying oil; the insert reduces the free flow cross-sectional area of the opening. It has been found that the reduced free flow cross-sectional area leads to reduced dogging of the opening with chips. This is possibly caused by the somewhat increased pressure as a result of the reduced free flow cross-sectional area. Moreover, it has been found that by reducing the free flow cross-sectional area wetting of the guide bar with oil can be improved. As a result of the reduced free flow cross-sectional area oil will remain adhered within the opening and will not run directly out of the opening to the base of the groove of the guide bar. In this way, the oil can be picked up by the drive links passing by. The oil consumption for lubrication of the saw chain is reduced.

Advantageously, the insert divides the free flow cross-sectional area into at least two passages. In particular, a plurality of passages is formed.

It can be provided that the insert has several individual bores. Guide bars are usually produced by a stamping process. The manufacture of several small bores is not possible by means of a stamping process because stamping does not allow for the production of arbitrarily small structures. The insert can be manufactured in a simple way. In this connection, it can be provided, for example, that the insert is made from plastic material and is produced by an injection-molding process. Also, the manufacture from metal or ceramic material can be advantageous. It can also be advantageous that the insert has a grid-like structure. The insert can then be cut or stamped in a simple way from the grid-like material. In order to achieve very many, very fine passages, it can be provided that the insert comprises a wiremesh that is provided with passages. In this connection, the wiremesh can be in particular comprised of a multi-layer configuration. In the fabric structures openings are formed as a result of the woven structure itself and they provide non-uniform passages.

It is provided that the insert has at least one bore whose longitudinal center axis is positioned relative to the exterior side of the guide bar at an angle of less than 90°. It has been found that by slantedly arranging an oil supply opening a reduced degree of soiling is achieved. The slantedly positioned bore can be produced in the insert in a simple way, for example, when the insert is made from plastic material, by an injection molding process. Also, machining of an insert from metal can be advantageous. It is provided that the longitudinal center axis of the bore is positioned relative to the exterior side of the guide bar at an angle that is approximately from 15° to approximately 45°. Expediently, the bore is also inclined in the longitudinal direction of the guide bar. For this purpose, it is in particular provided that the longitudinal center axis of the bore is positioned relative to the longitudinal center axis of the guide bar at an angle that is approximately from 30° to approximately 60°. The angle at which the longitudinal center axis of the bore is positioned relative to the longitudinal center axis of the guide bar can be changed in a simple way by changing the orientation of the insert in the opening. The opening is designed in this context in particular so as to match the drive projection of the drive link.

The insert can be secured in a simple way in the opening in that the insert is press-fit into the opening. However, it is also possible to employ different kinds of attachment of the insert, for example, by welding, soldering, gluing of the like. Advantageously, the insert is comprised at least partially of ceramic material. In this connection, a ceramic coating of the insert can be provided. It has been found that ceramic material has a minimal tendency to become soiled so that deposits of dirt are prevented by the ceramic material.

Advantageously, the area of the second sidewall of the guide bar that is opposite the opening is of a closed configuration. The guide bar therefore has an oil supply opening only on one longitudinal side, i.e., on the longitudinal side resting against the housing of a motor chain saw where an oil supply channel of a lubricant oil pump opens. The longitudinal center axis of the opening is advantageously positioned approximately perpendicularly to the exterior side of the guide bar. Accordingly, the opening can be produced in a simple way by a stamping method or by drilling or milling.

An excellent lubrication of the saw chain is achieved when the oil supply opening opens into the guide groove above the groove base and in an area where the drive links of the saw chain glide. In this way, the oil exiting from the insert can be entrained directly by the drive links. As a result of the reduced free flow cross-sectional area an oil film is formed on the surface of the insert across which oil film the drive links glide and entrain oil. In this way it is prevented that oil will run directly into the groove base and therefore cannot contribute to lubrication of the saw chain. In order to further improve the lubrication of the saw chain, it is provided that in the area of the opening at the base of the groove a raised portion is arranged that projects into the area across which the drive links of the saw chain will glide in operation.

Advantageously, the opening for supply of oil is designed as an oil bore. An oil bore, i.e., an oil supply opening with a round cross-section can be produced in a simple way.

### BRIEF DESCRIPTION OF THE DRAWINGS

Embodiments of the invention will be explained in the following based on the drawing.

FIG. 1 shows a schematic side view of a motor chain saw.

FIG. 2 is a detail section illustration of the guide bar of the motor chain saw of FIG.

FIG. 3 shows a section of the guide bar of FIG. 2 in the area of the oil bore.

FIG. 4 shows a side view of the guide bar of FIG. 3 in the direction of arrow IV of FIG. 3.

FIG. 5 shows a side view in the direction of arrow IV in FIG. 3 onto another embodiment of an insert for the guide bar.

FIG. 6 shows a side view in the direction of arrow IV in FIG. 3 onto yet another embodiment of an insert for the guide bar.

FIG. 7 shows a section of an embodiment of a guide bar in the area of the oil bore.

FIG. 8 is a side view in the direction of arrow VII in FIG. 7.

FIG. 9 is a section illustration of a guide bar at the time of producing a countersink

FIG. 10 shows the guide bar of FIG. 9 at the time of producing an oil bore.

### DESCRIPTION OF PREFERRED EMBODIMENTS

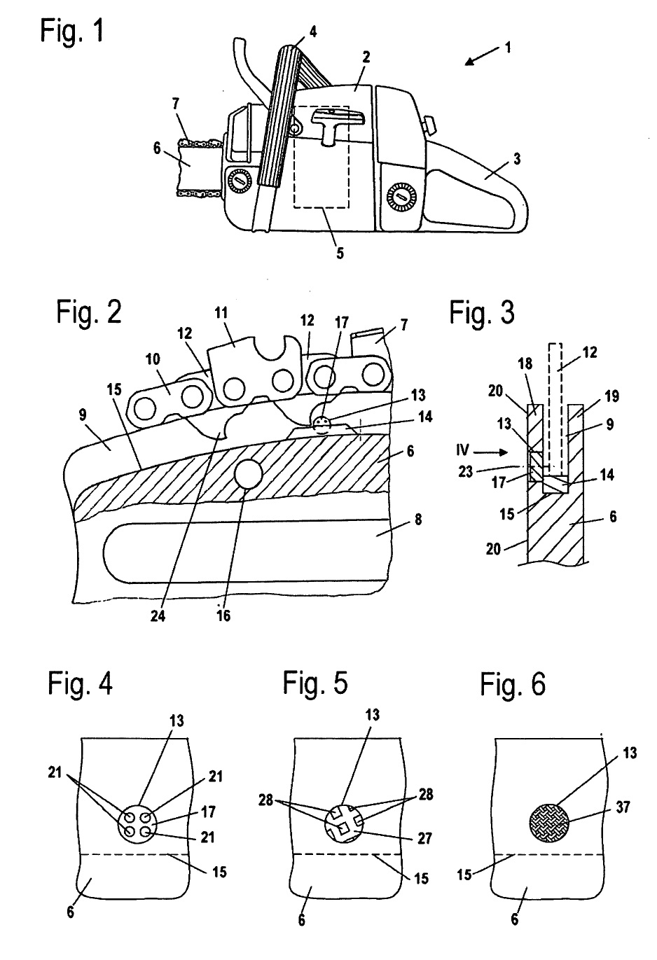

As an embodiment for a motor chain saw, FIG. 1 shows a hand-guided, hand-carried motor chain saw 1. The invention is however also useable in connection with other motor chain saws, for example, pole pruners or plantation harvesting machines, so-called harvesters.

The motor chain saw 1 has a housing 2 on which a rear handle 3 as well as a grip pipe 4 are secured. On the end of the housing 2 opposite the rear handle 3 a guide bar 6 projects forwardly and a saw chain 7 is arranged thereon peripherally. In the housing 2 a drive motor 5 is arranged that drives the saw chain 7 in circulation about the guide bar 6.

In FIG. 2 the area of the guide bar 6 secured to the motor chain saw 1 is shown in section. For fixation on the motor chain saw 1 the guide bar 6 has a longitudinal groove 8 as well as transverse bores 16 of which one is shown in FIG. 2. A tensioning device (not shown) for the saw chain 7 can engage the transverse bore 16. The guide bar 6 has at its outer circumference a circumferential guide groove 9 in which the saw chain 7 is guided. The saw chain 7 has connecting links 10; some of them are embodied as cutter links 11. The connecting links 10 are connected to one another by drive links 12. Each drive link 12 has a drive projection 24 that engages the guide groove 9.

For lubricating the saw chain 7 an opening opens into the guide groove 9 and is embodied as an oil bore 13. Instead of the oil bore another type of opening can be provided whose cross-section deviates from a circular shape. A cross-section deviating from the circular shape can be provided in particular in order to secure the rotational position of an insert arranged in the opening. As shown in FIG. 2, the oil bore 13 opens above the groove base 15 of the guide bar 9 into the guide groove 9. In the area of the oil bore 13 a ramp 14 is arranged at the groove base 15 and projects to a level near the drive projection 24 of the drive links 12.

As shown in the section illustration of FIG. 3, the guide groove 9 is delimited laterally by a first sidewall 18 and a second sidewall 19. In the first sidewall 18 the oil bore 13 is provided which extends from the exterior side 20 of the guide bar 6 through the first sidewall 18 into the guide groove 9. As shown in FIG. 3, the second sidewall 19 is closed in the area that is opposite the oil bore 13.

The openings that are introduced into the guide bar 6 are advantageously produced by a stamping process. In this connection, the oil bore 13 can be manufactured together with the longitudinal groove 8 and the transverse bore 16 in a single working step. However, the oil bore 13 can also be produced by other manufacturing processes, in particular by drilling or milling. In order to avoid clogging of the oil bore 13 with chips or the like and in order to improve the oil supply to the drive links 12 of the saw chain 7, an insert 17 is secured in the oil bore 13 that reduces the free flow cross-sectional area of the oil bore 13. The insert 17 is shown in a side view in FIG. 4 in the guide bar 6. In the shown embodiment, the insert 17 has four bores 21 that are distributed uniformly about the surface of the insert 17. It is also possible to provide any other number of bores 21. The bores 21 can also be provided as irregular openings, for example, when the insert 17 is comprised of plastic material and produced by an injection molding process. The insert 17 is advantageously press-fit into the oil bore 13. The insert 17 can also be attached in other ways to the oil bore 13, for example, by gluing, or when producing the insert 17 from metal, by welding or soldering. The insert 17 is comprised advantageously at least partially of ceramic material.

In FIG. 5 one embodiment of an insert 27 for the oil bore 13 is shown. The insert 27 is embodied as a grid and has a plurality of passages 28. The insert 27 is comprised advantageously of a metal grid and can be produced, for example, by stamping from a flat metal grid. However, the insert 27 can also be comprised of ceramic material and produced by sintering, for example. Also, a ceramic coating can be advantageous. The insert 27 is advantageously press-fit into the oil bore 13.

In the embodiment illustrated in FIG. 6 an insert 37 is provided that has a fabric structure. The insert 37 is advantageously a wiremesh, in particular a multi-layer wiremesh. In order to further reduce the free flow cross-sectional area it can be provided that the insert is a compressed wiremesh. When weaving wires with round cross-section, at the points of intersection passages are produced whose size depends on the density of the woven structure. The free flow cross-sectional area can be reduced by several fabric layers or by compressing the fabric layers. In this way, the desired free flow cross-sectional area can be adjusted. In order to reduce the tendency of soiling, a ceramic coating can be provided. Instead of a wiremesh, a porous ceramic structure can be advantageous.

In operation, as a result of the passages with reduced flow cross-sectional area an oil film is formed on the side of the insert 17, 27, 37 that projects into the guide groove 9. This oil film can be picked up by the drive links 12 passing it. In this way, a direct lubrication of the drive links 12 is possible in a simple way.

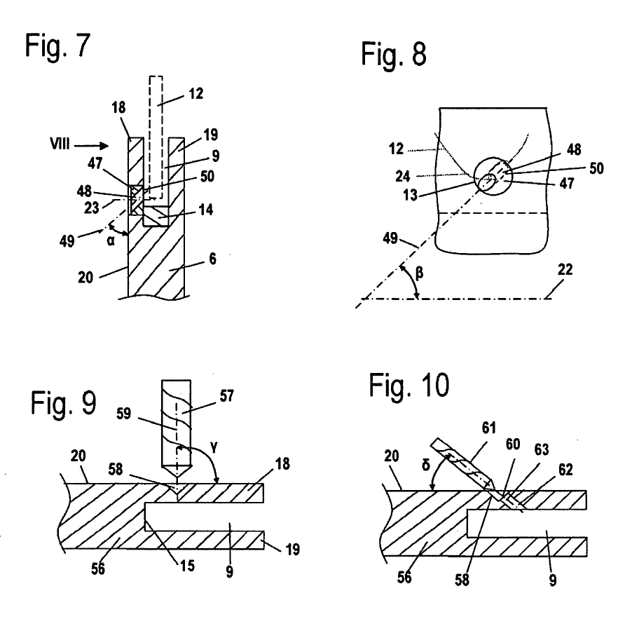

In FIGS. 7 and 8 an embodiment of a guide bar 6 is shown that has an insert 47 in the oil bore 13. The insert 47 has a passage 48 embodied as a bore with round cross-section. The passage 48 can also have another cross-section that is not round. In FIG. 7 the longitudinal center axis 23 of the oil bore 13 is also shown. As shown in FIG. 7, the longitudinal center axis 23 is positioned perpendicularly to the exterior side 20 of the guide bar 6. The passage 48 has a longitudinal center axis 49. The passage 48 is not arranged perpendicularly to the exterior side 20 of the guide bar 6 but is slanted relative thereto. The longitudinal center axis 49 of the passage 48 is positioned relative to the exterior side 20 of the guide bar 6 at an angle α that is smaller than 90°. The angle α is advantageously from approximately 15° to approximately 45°. In particular, the angle α is approximately 30°.

As shown in FIG. 8, the longitudinal center axis 49 of the passage 48 is also slanted relative to the longitudinal center axis 22 of the guide bar 6. The longitudinal center axis 49 is positioned relative to the longitudinal center axis 22 of the guide bar 6 at an angle β that is advantageously from approximately 30° to approximately 60°. In particular, the angle β is approximately 45°. FIG. 8 shows the arrangement of the mouth 50 of the passage 48 in the guide groove 9. The mouth 50 is arranged at the level of the drive projection 24 of the drive link 12. The contour of the mouth 50 corresponds approximately to the leading contour of the drive link 12 in the circulating direction of the saw chain 7 at this level. In this way, excellent lubrication of the drive link 12 can be achieved in a simple way.

Instead of providing an insert 17, 27, 37, 47, the oil bore can also be introduced directly into the sidewall 18 of the guide bar. This is shown in FIGS. 9 and 10 for a guide bar 56. With the exception of the design of the oil bore, the guide bar 56 corresponds in this connection to the guide bar 6 shown in FIGS. 1 through 8. Same reference numerals identify elements corresponding to one another. For producing an oil bore 62 (FIG. 10), by means of a countersink drill 57 a countersink 58 is first produced in the exterior side 20 of the first sidewall 18 of the guide bar 56. The center axis 59 of the countersink 58 that coincides with the longitudinal center axis of the countersink drill 57 is positioned at an angle γ relative to the exterior side 20 which angle is advantageously from approximately 75° up to approximately 90°. The angle γ is in particular approximately 90°.

In a second working step, illustrated in FIG. 10, the oil bore 62 is produced by means of a drill 61. The longitudinal center axis 63 of the oil bore 62 that coincides with the longitudinal center axis of the drill 61 is positioned at an angle δ relative to the exterior side 20 of the guide bar 56 that is smaller than 90°.

The angle δ is advantageously approximately 15° to approximately 45° and in particular approximately 300. The drill 61 is advantageously positioned approximately perpendicularly onto the sidewall 60 of the countersink 58. In this way, the tool wear of the drill 61 can be minimized.

The specification incorporates by reference the entire disclosure of German priority document 10 2007 060 683.6 having a filing date of Dec. 17, 2007.

While specific embodiments of the invention have been shown and described in detail to illustrate the inventive principles, it will be understood that the invention may be embodied otherwise without departing from such principles.

What is claimed is:

1. A guide bar arrangement comprising:
a guide bar having a guide groove that extends about an outer circumference of the guide bar;
a saw chain driven in circulation in the guide groove about the guide bar;
wherein the guide groove is delimited by a groove base, a first sidewall and a second sidewall positioned opposite the first sidewall;
wherein the guide bar has an opening for supply of oil into the guide groove, wherein the opening extends from an exterior side of the guide bar, which exterior side extends in a longitudinal direction of the guide bar, into the guide groove and opens in the first sidewall into the guide groove;
an insert secured in the opening and reducing a free flow cross-sectional area of the opening.

2. The guide bar arrangement according to claim 1, wherein the insert divides the free flow cross-sectional area of the opening into at least two passages.

3. The guide bar arrangement according to claim 2, wherein the insert comprises several individual bores.

4. The guide bar arrangement according to claim 2, wherein the insert has a grid-shaped structure.

5. The guide bar arrangement according to claim 2, wherein the insert comprises a wiremesh provided with passages.

6. The guide bar arrangement according to claim 1, wherein the insert has at least one bore whose longitudinal center axis is positioned relative to the exterior side of the guide bar at a first angle of less than 90°.

7. The guide bar arrangement according to claim 6, wherein the angle of the longitudinal center axis of the bore relative to the exterior side of the guide bar is from approximately 15° to approximately 45°.

8. The guide bar arrangement according to claim 6, wherein the longitudinal center axis of the bore is positioned relative to a longitudinal center axis of the guide bar at a second angle that is from approximately 30° to approximately 60°.

9. The guide bar arrangement according to claim 1, wherein the insert is press-fit into the opening.

10. The guide bar arrangement according to claim 1, wherein the insert is at least partially comprised of ceramic material.

11. The guide bar arrangement according to claim 1, wherein an area of the second sidewall of the guide bar that is opposite the opening is closed.

12. The guide bar arrangement according to claim 1, wherein a longitudinal center axis of the opening is positioned approximately perpendicularly to the exterior side of the guide bar.

13. The guide bar arrangement according to claim 1, wherein the opening opens into the guide groove above the groove base in an area past which area drive links of the saw chain glide.

14. The guide bar arrangement according to claim 1, wherein in an area of the opening a raised portion is arranged at the groove base and the raised portion projects into an area past which area drive links of the saw chain glide in operation.

15. The guide bar arrangement according to claim 1, wherein the opening for supply of oil is embodied as an oil bore.
